(19) United States
(12) Patent Application Publication
(10) Pub. No.: US 2006/0213753 A1
(43) Pub. Date: Sep. 28, 2006

(54) Rotary knob and control panel, in particular for a ventilation, heating and/or air-conditioning installation

(75) Inventors: Patrick Corduan, Guignes (FR); Andre Chery, Ozoir La Ferriere (FR); Louis Lacroix, Champigny Sur Marne (FR); Laurent Lucaora, Vanves (FR)

Correspondence Address: Valeo Climate Control Corp.;Intellectual Property Dept, 4100 North Atlantic Boulevard, Auburn Hills, MI, 48326, US

(73) Assignee: Valeo Systemes Thermiques S. A. S., Le Mesnil St Denis (FR)

(21) Appl. No.: 11/385,001

(22) Filed: Mar. 20, 2006

(30) Foreign Application Priority Data
Mar. 22, 2005 (FR) 05 02809

(51) Int. Cl. H01H 19/00

(52) U.S. Cl. 200/19.18

(57) ABSTRACT

This invention relates to rotary knob 1, in particular for a control panel for a ventilation, heating and/or air conditioning installation, comprising a gripping area 2, and an activation area 9, characterized in that it has at least two shoulders 5, 6, each shoulder comprising at least one indexing means 7 for blocking the said knob in rotation, the shoulders 5, 6 supporting a different number of indexing means 7. It is applicable to ventilation, heating and/or air conditioning installations inside a motor vehicle.

The technical field of this invention is control panels for motor vehicles. These control panels are in particular used to control a ventilation, heating and/or air conditioning installation installed inside the vehicle.

Among known devices, control panels make use of rotary knobs, sliding buttons, push buttons or a combination of these three functional modes. For air conditioning installations, it is not unusual to find a control panel using three rotary knobs. The first rotary knob is dedicated to temperature regulation inside the passenger compartment of the vehicle, controlling a mixing valve inside the installation or a flow valve for cooling liquid passing through a heat exchanger located inside the air conditioning installation. The second rotary knob is designed to control air distribution modes. The objective is to direct air towards specific areas in the passenger compartment such as defrosting, ventilation, the foot area and/or the area at the back. The third knob controls the air flow rate to be supplied to the vehicle passenger compartment. It should be noted that this knob controls the velocity of a blower fan located inside the air conditioning installation.

These three knobs control different functions. Thus, the knob dedicated to temperature regulation requires a large number of regulation points since it can regulate a temperature variation of 0.5° C. for a temperature range varying from 16° C. to 26° C. It must be possible to put the passenger compartment temperature regulation knob in a large number of different positions.

It must be possible to put the knob dedicated to distribution modes in a minimum of three positions.

Finally, it must be possible to put the knob dedicated to control of the blower fan in a minimum of three positions corresponding to a range between “no ventilation” and “maximum ventilation.”

It should be noted that the number of positions is different for the different functions.

Devices according to prior art perform the functions explained above using a specific knob for each function.

However, these devices suffer from major disadvantages.

One of the principal disadvantages is that the reference of each knob is different from its neighbor, increasing difficulties with the logistics related to assembly of this type of product.

Another disadvantage of the state of the art mentioned above is that the manufacturing cost of these knobs is not optimized.

It can be understood that as a result, there is no standardization of parts forming a control panel for these known devices, and management of part diversity becomes more difficult.

Consequently, the technical problem to be solved by the purpose of this invention is a rotary knob and a control panel that in particular enable a reduction in the number of part references while simplifying the assembly of this type of control panel.

The solution provided by this invention to the technical problem that arises consists of providing the rotary knob with a gripping area, an activation area and at least two shoulders, each shoulder comprising at least one indexing means for blocking rotation of the said knob, the shoulders supporting a different number of means of indexation. Therefore, the same knob with the same reference can be used to fulfill two different functions.

According to a first characteristic of the invention, said shoulders are intermediate between the gripping area and the activation area.

According to a second characteristic of the invention, the activation area comprises a toothed wheel. This toothed wheel makes it easy to control a gearwheel that may for example be linked to a potentiometer.

According to another characteristic of the invention, the said shoulders are composed of a first shoulder and a second shoulder, the first shoulder supports a larger number of indexing means than the second shoulder, since the first shoulder is intermediate between the gripping area and the second shoulder.

According to another characteristic of the invention, the rotary knob comprises three shoulders. Thus, it becomes possible to control three different functions using a knob with the same reference.

According to another characteristic of the invention, said shoulders are composed of a first shoulder with a diameter greater than a second shoulder, this second shoulder having a diameter greater than a third shoulder.

The second shoulder is intermediate between the first and the third shoulder, the first shoulder being located on the side of the gripping area.

Advantageously, the first shoulder supports a larger number of indexing means than the second shoulder, the second shoulder supporting a larger number of indexing means than the third shoulder.

Also advantageously, the indexing means is in the form of a recess formed on the outer periphery of the shoulder.

Another purpose of the invention is a control panel, in particular for a ventilation, heating and/or air conditioning installation, characterized in that it comprises at least one rotary knob like that defined above.

Moreover, this invention also relates to a control panel for a ventilation, heating and/or air conditioning installation for a motor vehicle comprising at least two rotary knobs with each of which at least one spring fixed to a support of the control panel is associated, characterized in that each knob comprises a gripping area, an activation area and at least a first and a second shoulder, each shoulder comprising at least one indexing means for blocking the said knob in rotation, the shoulders supporting a different number of indexing means, one of the said springs is capable of cooperating with the indexing means of the first shoulder of one of the knobs, while the other spring is designed to cooperate with the indexing means located on the second shoulder of the other knob.

Advantageously, the support has a back face on which the springs are fixed, one of the springs being fixed to the support at a distance greater than the distance separating the other spring from the back face.

Other characteristics, details and advantages of the invention will appear more clearly after reading the description given below as an example with reference to the figures, in which:

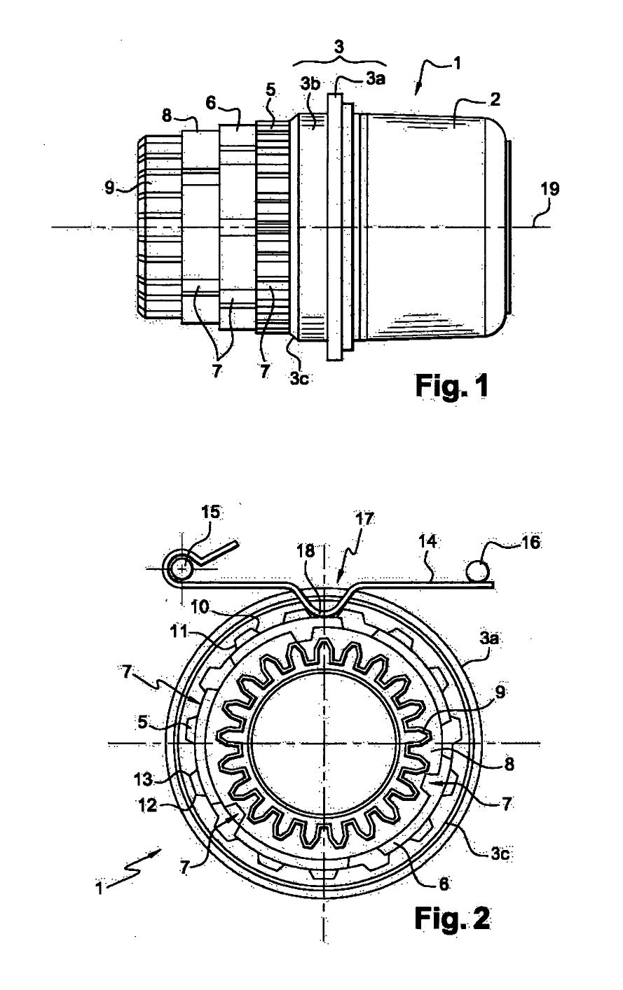

FIG. 1 is a side view of the rotary knob according to the invention,

FIG. 2 is a back view of the rotary knob according to the invention,

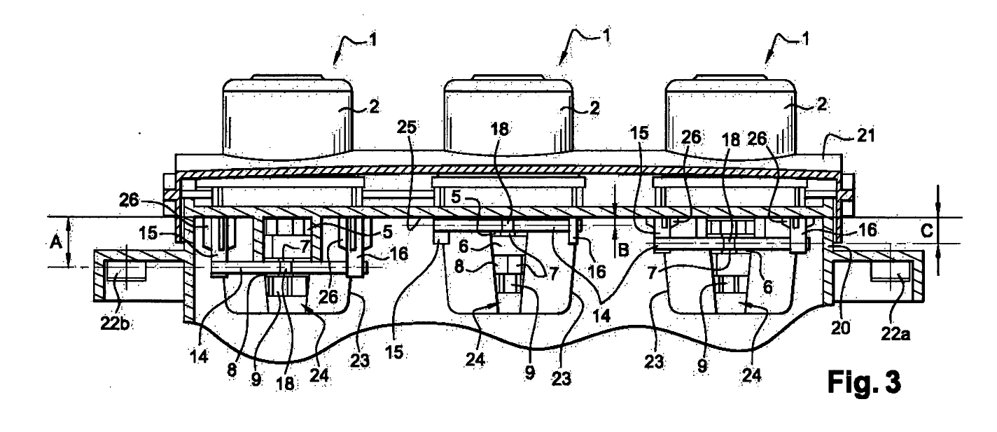

FIG. 3 is a top view of a control panel according to the invention,

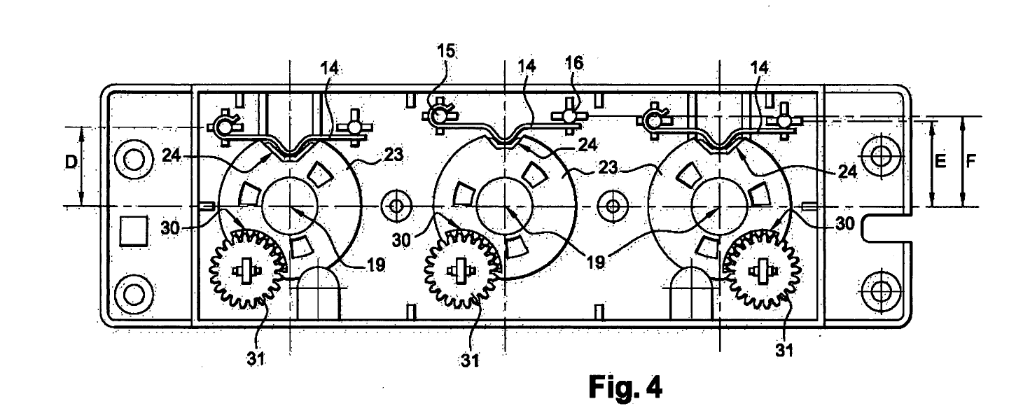

FIG. 4 is a back view of the control panel shown in FIG. 3.

The figures are illustrations of a specific embodiment and can be used to define the invention if necessary.

FIG. 1 shows a rotary knob 1 substantially cylindrical in shape which rotates around 1 an axis of rotation reference 19. This rotary knob comprises a gripping area 2 at a first end that the user can use to move the button. This gripping area 2 has a coating on its outer part, the purpose of which is to make the feel of the button 1 more comfortable for the user. Advantageously, this coating is of the insert molded type and is checkered so as to avoid any slipping when holding the gripping area.

There is a ring 3 adjacent to the gripping area 2 with a first cylindrical part 3a and a second cylindrical part 3b. The diameter of the second cylindrical part 3b is less than the diameter of the first cylindrical part 3a. The second cylindrical part 3b has a chamfer 3c at the end of the second part 3b opposite the first part 3a.

The cylinder formed by the rotary knob 1 is continued by at least two shoulders 5, 6 that will be referred to as the first shoulder 5 and the second shoulder 6 in the rest of the description. These two shoulders support at least one indexation means 7 on their outer periphery. The number of these indexing means is different on the two shoulders 5 and 6. It should be noted that the diameter of the first shoulder 5 is less than the diameter of the second part 3b. Similarly, the diameter of the second shoulder 6 is less than the diameter of the first shoulder 5. In the variant shown in FIG. 1, the rotary knob 1 comprises a third shoulder 8 that itself also supports at least one indexing means 7.

The indexing means 7 are distributed around the periphery of the first shoulder 5, for example at angular intervals equal to fifteen degrees.

These indexing means are distributed around the periphery of the second shoulder 6, for example at every forty-five degrees, although they are distributed for example at every sixty degrees when the latter are supported by the third shoulder 8.

The rotary knob 1 finishes at the end opposite the end of the gripping area 2 in an activation area 9. This activation area forms the part that transmits the movement requested by the user. In the preferred example, this activation area 9 is in the form of a straight spur gear but any other form would be possible such as a bevel gear so as to make an angle transmission or a direct actuation lever.

It should be understood from the above description that the shoulders 5, 6 and 8 are intermediate between the gripping area 2 and the actuation area 9, but another arrangement could be adopted if the gear in the actuation area has to be placed between the shoulders or adjacent to ring 3, for engineering reasons.

In the example shown in FIG. 1, it can be seen that the first shoulder 5 comprises a larger number of indexing means 7 distributed around its periphery than the second shoulder 6. The same is true for the second and third shoulders, the latter supporting fewer indexing means 7 than the second shoulder 6.

The gripping area 2, at least two shoulders 5, 6 and the actuation area 9, form a single piece, i.e. made up of a single material and manufactured simultaneously by molding.

FIG. 2 shows the rotary knob 1 in a view from behind, i.e. by viewing it from the activation area 9. The largest diameter is made up of the first cylindrical part 3a and the circle shown in bold lines shows the chamfer 3c.

The first shoulder 5 shows fifteen indexation means 7, as an example. An indexing means 7 is in the form of a recess formed around the outer periphery of the shoulder 5 and in the material from which this shoulder is made. This recess has flat parts 10, 11, and chamfers 12, 13 chosen so as to block rotation of the rotary knob 1 while allowing its movement without excessive effort by the user.

This indexing means 7 cooperates with a spring or spring leaf 14 held on a support by means of two pins 15 and 16. Spring 14 is partially coiled around the first pin 15 and is held in contact with the second pin 16. The spring 14 also comprises a deformation 17 that cooperates with the recess formed in first shoulder 5. This deformation 17 comprises a rounded area 18 that bears on the bottom of the recess and on the flats 10 and/or 11. It should thus be noted that the spring 14 is held blocked by a force applied on the rounded area 18, this effort being resisted by the pins 15 and 16.

In this example embodiment, the second shoulder 6 comprises five indexing means 7 while the third shoulder 8 comprises three indexing means. It should be noted that the rotary knob 1 may be hollow at its center or full of material.

One particularly advantageous application of the rotary knob 1 according to the invention is in control panels, particularly in order to control a ventilation, heating and/or air conditioning installation for a motor vehicle.

FIG. 3 shows a top view of a control panel of this type. This control panel comprises a support 20 shown partially and upon which a facade 21 visible to the user is mounted. This control panel comprises three rotary knobs of the type described with reference to FIGS. 1 and 2. The main constitution of these three knobs 1, i.e. the presence of a gripping area, an actuation area and at least two shoulders supporting a different number of indexing means, is identical. It should therefore be understood that these three rotary knobs 1 are derived from the same manufacturing mould and have the same logistic reference.

Support 20 has two projections through which a fixation hole is made to fix the control panel onto the dashboard of the vehicle.

The facade 21 covers the periphery of the support 20 and is provided with holes through which the gripping area of each of the rotary knobs 1 projects. Similarly, support 1 comprises reception cavities 23 for the rotary knobs 1. These cavities 23 are shaped like a basin inside which the shoulders 5, 6 and/or 8 and the actuation area 9 are located. Each of these reception cavities 23 comprises an opening 24 which makes it possible for the spring 14 to interact with shoulders 5, 6 or 8.

The spring 14 provided for each rotary knob 1 is fixed on the support 20 through pins 15 and 16. These pins project substantially perpendicularly from a back face 25 of the support 1. The length of these pins 15 and 16 depends on the position of the spring 14, which is itself defined by the shoulder 5, 6 or 8 that acts on the spring 14.

It should be noted that the pins 15 and 16 used for the rotary knobs 1 located to the left and the right of FIG. 3 comprise stiffeners 26 to prevent any bending of the pins 15 or 16.

The rotary knob 1 to the left of the figure cooperates with the spring 14 through the shoulder 8. The rounded area 18 of this spring is in the blocked position in one of the indexing means 7 supported by the shoulder 8. Since this shoulder 8 is the shoulder furthest from the gripping area 2, it is observed that the spring 4 is at a distance A from the back face 25 of the support 20.

The rotary knob 1 at the center of FIG. 3 cooperates with a spring 14 located in contact with the back face 25 of the support 20. In this position, the rounded area 18 of the spring is in contact with an indexing means 7 supported by the first shoulder 5. The location of the spring 14 relative to the back face 25 can be materialized by a distance B that is less than the distance A. The first shoulder 5 supporting an indexing means 7, the second shoulder 6 in an area in which an indexing means 7 is not visible, the third shoulder 8 and its indexing means 7, and finally the actuation area 9, can be seen through the hole 24.

The rotary button 1 located at the right of the figure cooperates with a spring 14 located at a distance C from the back face 25 of the support 20. This distance C is greater than the distance B but is less than the distance A. It is observed that the length of the pins 15 and 16 used with this knob is greater than the length of the pins used for the knob located at the center. The rounded area 18 of the spring 14 bears on the second shoulder 6 through the indexing means 18.

It can be understood from the description of FIG. 3 given above that if identical knobs are used, the location of the spring 14 relative to the rotary button 1 determines the function of the button and thus distinguishes it from the other rotary knobs.

FIG. 4 represents the back part of the control panel according to the invention. It includes the three reception cavities 23 and their corresponding holes reference 24. These reception cavities 23 comprise another opening 30 that enables the actuation area 9 to act on a gearwheel 31. This gearwheel is of the toothed wheel type to cooperate with the toothed wheel in the actuation area 9.

The diameter of the shoulders 5, 6 and/or 8 can be identical. However, in the variant shown in this figure, each shoulder has a different diameter, the diameter of the first shoulder 5 being greater than the diameter of the second shoulder 6, which is itself greater than the diameter of the third shoulder 8. This is why the location of the spring 14 with respect to the rotation axis 19 of the knob is important. Thus, the spring 14 used with the rotary button 1 shown at the left of FIG. 4 is at a distance D from an axis passing through the axis of rotation 19. This distance D corresponds to use of the spring 14 in combination with the shoulder 8.

It is observed that the spring 14 (materialized by a spindle passing through the two pins 15 and 16) for the rotary button 1 located at the center of FIG. 4 is at a distance F from the rotation axis 19. This distance F is applicable for use of the spring 14 with the first shoulder 6.

The rotary knob 1 located to the right of FIG. 4 cooperates with a spring 14 through the second shoulder 6. In this case, the spring 14 is located at a distance E from the rotation axis 19 of the rotary knob 1.

It can be seen in this figure that the distance E is greater than the distance D, while remaining less than the distance F.

We will now describe operation of the rotary knob with reference to FIGS. 1 and 2.

When the user grips the rotary knob 1 using the gripping area 2, he applies a turning force so as to put the button at a chosen location for the function controlled by the knob. When the user applies this force, the rounded area 18 of the spring 14 bears on one of the flats 10 or 11 of the indexing means 7. The user then feels a force to be overcome to rotate the knob. This force is created by bending of the spring 14.

The shape of this recess controls the sensitivity felt by the user each time that the knob is blocked in rotation. It can thus be understood that this sensitivity is controlled by the angle of the flats 10 and 11 in combination with the position of the spring relative to the shoulder concerned and the stiffness of the spring 14.

In the control panel shown in FIGS. 3 and 4, three identical rotary knobs 1 are used and are installed in the reception cavities 23. Each of these knobs will be used to control a different function.

In the case of a control panel for a ventilation, heating and/or air conditioning installation, the function performed by the rotary knob 1 on the left part of FIGS. 3 and 4 is (as an example) control of the air flow in the installation. For example, the number of positions necessary to perform this function might be three, so as to control the blower fan installed in the installation at three speeds.

The function of the rotary knob 1 at the center of FIGS. 3 and 4 requires a larger number of positions because it is specifically designed for temperature control inside the vehicle passenger compartment. In this example, the first shoulder 5 comprises fifteen indexing means each corresponding to a temperature requested by the user.

The rotary knob 1 at the right of FIGS. 3 and 4 is designed to control distribution in the air conditioning installation. In the example shown herein, the distinction between this knob and the other two knobs is made by the position of the spring 14 that cooperates with the shoulder 6, this shoulder having five distribution positions such as feet-only position, feet and ventilation position, feet and defrost position, defrost-only position, and ventilation and defrost position.

In summary, the control panel uses two rotary knobs 1 with an identical structure, but uses different parts of this knob, in other words shoulders 5, 6 and indexing means 7, so that each rotary knob 1 can perform a different function.

1. Rotary knob (1), in particular for a control panel for a ventilation, heating and/or air conditioning installation, comprising a gripping area (2), an activation area (9), characterized in that it has at least two shoulders (5, 6), each shoulder comprising at least one indexing means (7) for blocking the said knob in rotation, the shoulders (5, 6) supporting a different number of indexing means (7).

2. Rotary knob according to claim 1, characterized in that the said shoulders (5, 6) are intermediate between the gripping area (2) and the actuation area (9).

3. Rotary knob according to either claim 1 or 2, characterized in that the actuation area (9) includes a toothed wheel.

4. Rotary knob according to any one of the previous claims, characterized in that the said shoulders (5, 6) comprise a first shoulder (5) and a second shoulder (6), the first shoulder (5) supports a larger number of indexing means (7) than the second shoulder (6), since the first shoulder (5) is intermediate between the gripping area (2) and the second shoulder (6).

5. Rotary knob according to any one of claims 1 to 3, characterized in that it comprises three shoulders (5, 6, 8).

6. Rotary knob according to claim 5, characterized in that the said shoulders (5, 6, 8) are composed of a first shoulder (5) with a diameter greater than a second shoulder (6), this second shoulder having a diameter greater than a third shoulder 8).

7. Rotary knob according to claim 6, characterized in that the second shoulder (6) is intermediate between the first (5) and the third shoulder (8), the first shoulder (5) being located on the side of the gripping area (2).

8. Rotary knob according to either claim 6 or 7, characterized in that the first shoulder (5) supports a larger number of indexing means (7) than the second shoulder (6), the second shoulder supporting a larger number of indexing means (7) than the third shoulder (8).

9. Rotary knob according to any one of the previous claims, characterized in that the indexing means (7) is in the form of a recess formed on the outer periphery of the shoulder.

10. Control panel, in particular for a ventilation, heating and/or air conditioning installation, characterized in that it comprises at least one rotary knob (1) according to any one of the previous claims.

11. Control panel for a ventilation, heating and/or air conditioning installation for a motor vehicle comprising at least two rotary knobs (1) with each of which at least one spring (14) fixed to a support (20) of the control panel is associated, characterized in that each knob (1) comprises a gripping area (2), an activation area (9) and at least a first (5) and a second (6) shoulder, each shoulder comprising at least one indexing means (7) for blocking the said knob in rotation, the shoulders (5, 6) supporting a different number of indexing means (7), one of the said springs (14) is capable of cooperating with the indexing means (7) of the first shoulder (5) of one of the knobs, while the other spring (14) is designed to cooperate with the indexing means (7) located on the second shoulder (6) of the other knob.

12. Control panel according to claim 11, characterized in that the support (20) has a back face (25) on which the springs (14) are fixed, one of the springs being fixed to the support at a distance greater than the distance separating the other spring from the back face (25).
